(19) United States
(12) Patent Application Publication
(10) Pub. No.: US 2014/0151509 A1
(43) Pub. Date: Jun. 5, 2014

(54) CAPSULE SYSTEM, SERVICE MODULE, AND REUSEABLE REENTRY PAYLOAD AND DOCKING MODULE

(71) Applicant: John Zelon, Houston, TX (US)

(72) Inventor: John Zelon, Houston, TX (US)

(21) Appl. No.: 14/234,402

(22) PCT Filed: Jan. 26, 2012
(86) PCT No.: PCT/US2012/022799

§ 371 Date: Jan. 23, 2014

Related U.S. Application Data
(63) Continuation of application No. PCT/US11/01305, filed on Jul. 23, 2011.
(60) Provisional application No. 61/400,117, filed on Jul. 22, 2010.

(51) Int. Cl. B64G 1/60; B64G 1/64; B64G 1/62

(52) U.S. Cl. CPC B64G 1/60; B64G 1/62; B64G 1/646
USPC 244/158.9

(57) ABSTRACT

A modular spacecraft comprising:

a capsule module comprising a common bulkhead, and

an additional spacecraft module comprising a common bulkhead, wherein said capsule modules common bulkhead is attached to said additional spacecraft module's common bulkhead.

### BACKGROUND

The invention relates generally to spacecraft and more particularly to reusable modular vehicles capable of orbital boost, reentry, docking, and carrying payloads or passengers.

Capsules, such as the Almaz capsule are known in the art. Service modules such as those from the Apollo program are known in the art. Space stations, such as the International Space Station are known in the art.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION

This invention pertains to the structure and function of spacecraft. Specifically, this invention is in the field of spacecraft having a modular design. A spacecraft in accordance with certain embodiments of the present invention provides capability for orbital boost to a higher altitude, rendezvous, docking and return of a capsule and a reusable payload module for use with a commercial space station facility. To allow for the spacecraft to be adaptable to multiple functional roles without the need for redesign and re-fabrication, embodiments of the spacecraft architecture can comprise independent modules each comprising a common bulkhead. These modules can be combined together in different combinations in order to give the spacecraft the hardware necessary to achieve different functional roles presented by the mission at hand.

### DRAWINGS

These and other features, aspects, and advantages of the present invention will become better understood when the following detailed description is read with reference to the accompanying drawings in which like characters represent like parts throughout the drawings, wherein:

FIG. 1 shows a spacecraft in accordance with an embodiment of the present invention comprising a nosecone 10, a capsule module 1, a service module 2, and a fairing 60.

FIG. 2 shows a service module 2 comprising a pressurized tunnel 70 and unpressurized support structure 50 in accordance with an embodiment of the present invention.

FIG. 3 shows a service module 2 comprising a pressurized tunnel 70 and unpressurized support structure 50 in accordance with an embodiment of the present invention.

FIG. 4 shows a service module 2 and a habitable module 3 in accordance with an embodiment of the present invention.

FIG. 5 shows a service module and a habitable module 3 in accordance with an embodiment of the present invention.

FIG. 6 shows a payload return capsule reentry diagram.

FIG. 7 shows a human space vehicle in accordance with the present invention comprising a nosecone 10, a capsule module 1 comprising a capsule 20, and an escape tower 90.

Shown in FIG. 8 is a spacecraft in accordance with an embodiment of the present invention comprising a service module 2 and a D-shaped pressurized cargo module 110.

Shown in FIG. 9 is a spacecraft in accordance with an embodiment of the present invention comprising a service module 2 and a D-shaped pressurized cargo module 100.

Shown in FIG. 10 is a spacecraft in accordance with an embodiment of the present invention comprising a service module 2 and a habitable module 3.

Shown in FIG. 11 is a spacecraft in a long range tourist configuration in accordance with an embodiment of the present invention comprising a nosecone 10, a capsule module 1, a service module 2, and a habitable module 3.

Shown in FIG. 12 is a spacecraft in a pressurized cargo transport configuration in accordance with an embodiment of the present invention comprising a nosecone 10, a capsule module 1, a service module 2, and a D-shaped pressurized cargo module 110.

Shown in FIG. 13 is a spacecraft in an unpressurized cargo transport configuration in accordance with an embodiment of the present invention comprising a nosecone 10, a capsule module 1, a service module 2, and an unpressurized cargo module 170.

### DETAILED DESCRIPTION

The modular aspect of spacecraft architecture in accordance with an embodiment of the present invention is based on a common bulkhead. This common bulkhead is a circular sheet of rigid material that is preferably the same interior diameter of the cargo modules. The common bulkhead can itself serve multiple purposes by having a hatch, a window, a cupola, or some other feature, usually at the center of the common bulkhead. The common bulkhead could also be solid rigid material with no penetrations. The majority of modules that can affix to the spacecraft architecture do so through either being affixed to another module being separated by the common bulkhead or attaching to a hatch located in the center of the common bulkhead.

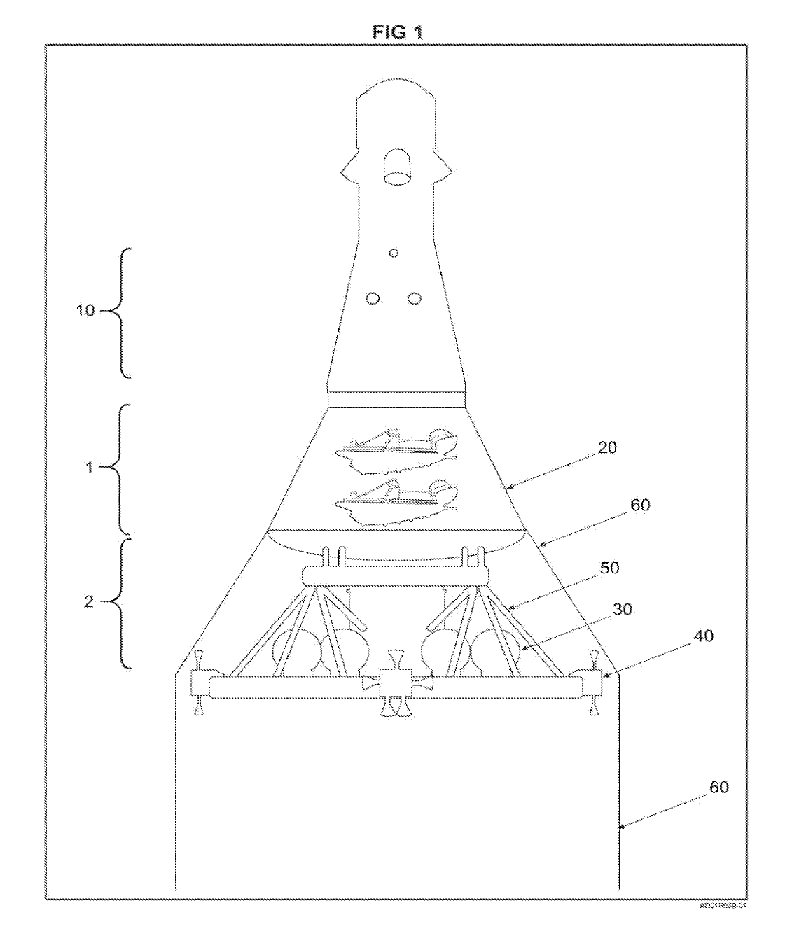

Shown in FIG. 1 is a spacecraft in accordance with an embodiment of the present invention comprising a capsule module 1, a service module 2. A capsule module according to an embodiment of the present invention could comprise a capsule 20 and a common bulkhead. A fairing 60 may be positioned around the circumference of the service module 2 in this configuration. The combination provides unique capabilities for transport of crew and payloads to an orbiting commercial space station.

A spacecraft in accordance with an embodiment of the present invention can provide for: orbital boost to a higher altitude of a ground launched capsule 1; fine positioning. rendezvous and docking with a space station; and separation, de-orbit and reentry of a reusable capsule 1.

service module 2 in accordance with an embodiment of the present invention as shown in FIGS, 1, 2, 3, 4, 5, 8, 9, 10, 11, 12, and 13 can provide structure 50, tankage 30, plumbing, avionics, additional power, motors 40 for coarse and fine alignment and de-orbit, and a tunnel 70 for pressurized exchange of crew and payloads between modules, such as the payload docking module 3 and the capsule 1 as shown in FIG. 1.

The payload docking module 3 is reusable and provides all the elements needed for docking; the pressurized environment for payload storage and crew direction of proximity operations, rendezvous and docking system control. A payload docking module 3 can be derived from the basic capsule 1 modified to include the docking system and a modified. parachute landing system.

The service module 2 provides the maneuverability for the capsule module 1 and payload and docking module 3 to raise the combined vehicle altitude and allow for rendezvous and docking with a commercial space station. The payload and docking module 3 provides the docking system and payload capacity to support space station logistics. The combination of the crew capsule 1, service module 2 and payload and docking module 3, as shown in FIG. 11, provides the integrated system for transport of crew and payloads to and from an orbiting space station.

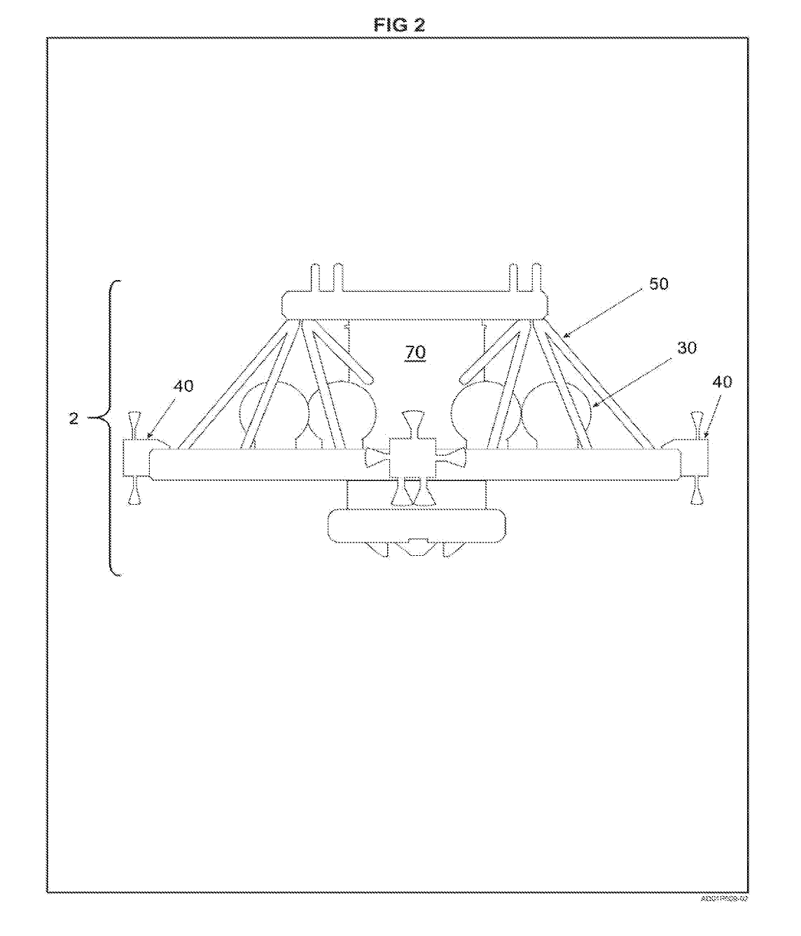

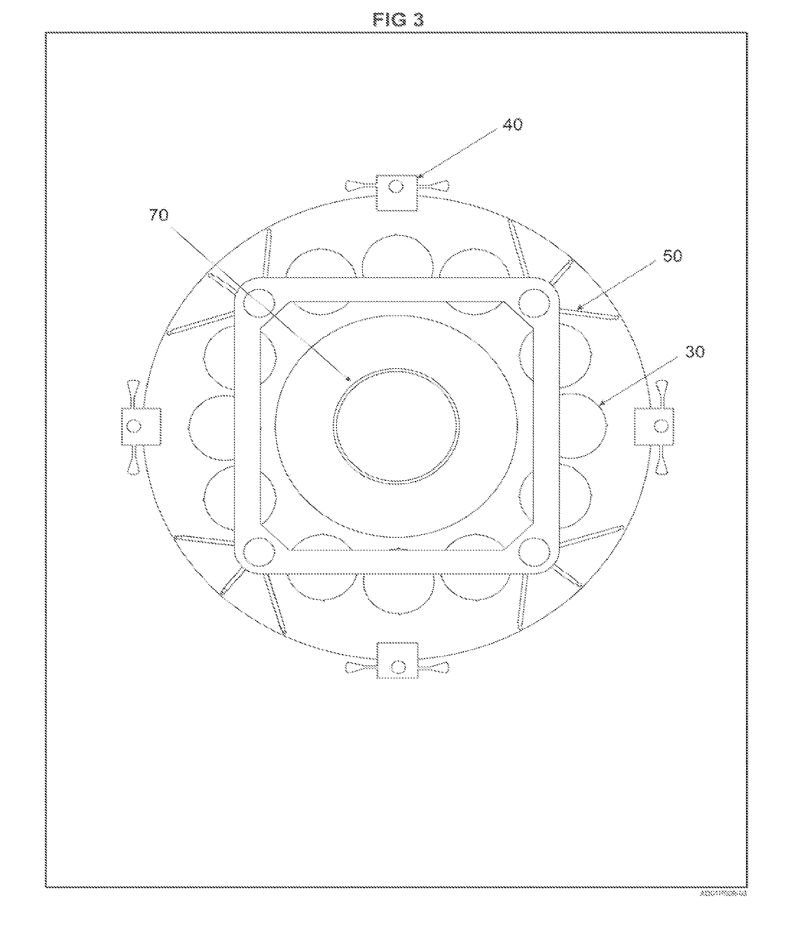

The modularity of the design of the service module 2, as shown in FIGS. 2 and 3, allows for simple modification to support space stations located at higher or lower altitudes.

Certain components of a spacecraft in accordance with an embodiment of the present invention can be based on highly mature spaceflight hardware to provide the ability to reuse approximately 20-35 times multiple high cost elements of the payload and docking module 3. Specifically, in certain embodiments of the present invention the payload docking module 3 could comprise a reentry capsule, such as a Soyuz or Almaz capsule. The combination of elements proposed can provide a very cost effective approach for routine travel to and from any compatible space station.

An embodiment wherein service module 2 is stacked at the bottom of the vehicle can perform a space tug function. Configuring an embodiment with the service module 2 on bottom allows for reuse of service module 2. In a space tug embodiment, the service module 2 would function in the same basic manner as other embodiments. Optionally, the payload docking module 3 could comprise a Soyuz OM or other capsule rather than an Almaz capsule. An embodiment comprising an Almaz capsule has the capability for return of payloads in the Almaz capsule 20 reentry vehicle.

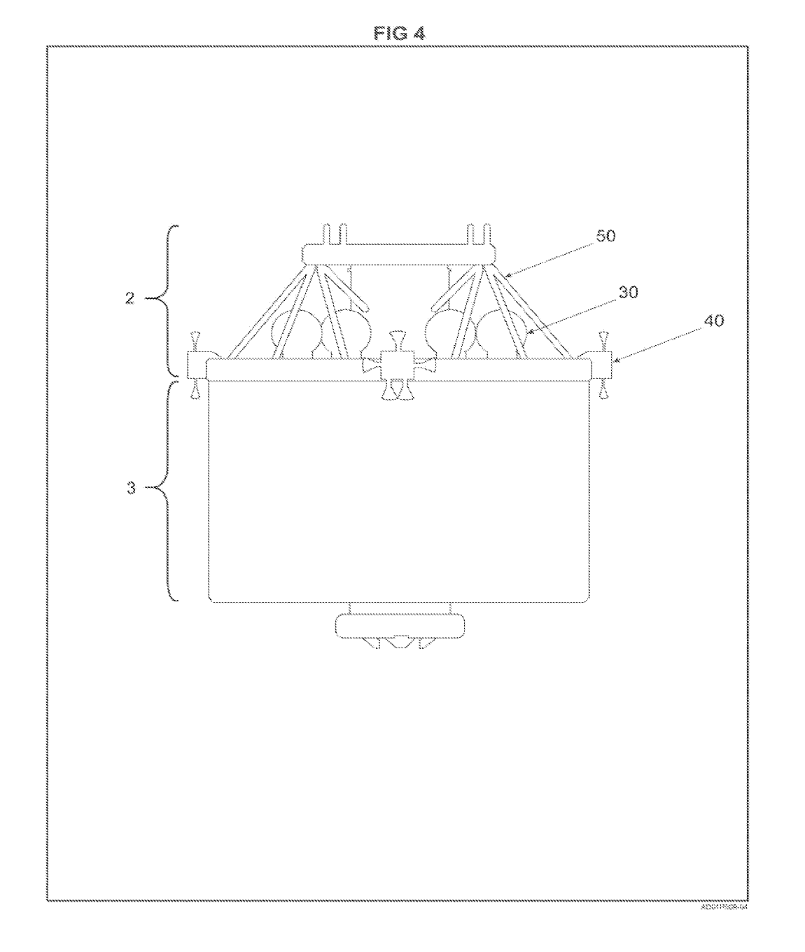

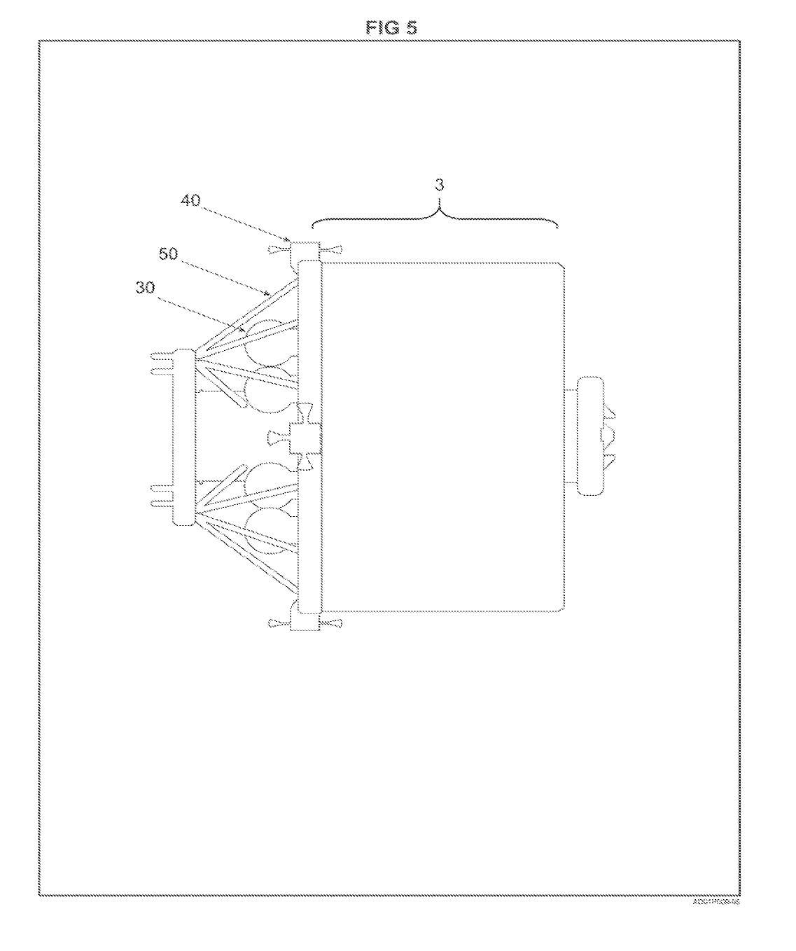

FIGS. 4 and 5 show an embodiment comprising a payload, docking module 3 and a service module 2 with air resupply and propellant tanks 30, fine attitude thrusters 40 for rendezvous and docking and course thrusters 40 for major delta velocity addition.

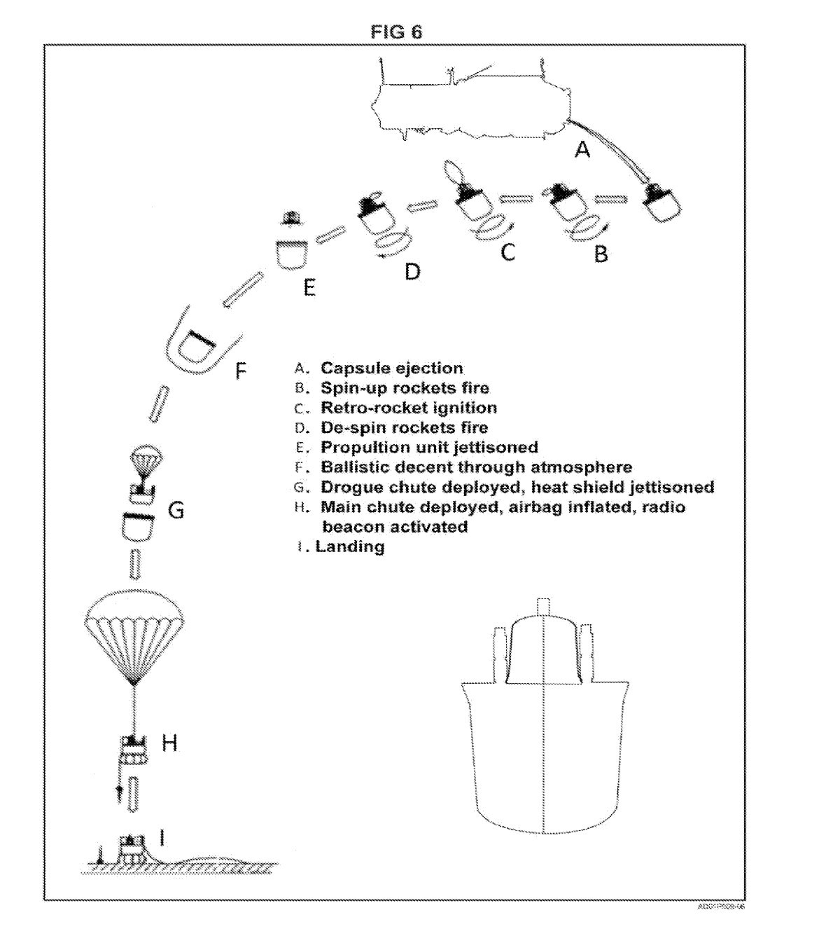

Certain embodiments of the present invention could comprise a service module 2 having payload return capability. A payload return vehicle is shown in FIG. 6. Certain embodiments could comprise one or more payload return vehicles. Payload return vehicles could be based on an existing Russian design.

FIG 6 shows a payload return capsule reentry diagram. After ejection from the space craft (step A) it spins up (step B) by a small solid, rocket motor. Then the main retro rocket tires (step C) and after burnout another small solid rocket tires (step D) to de-spin the capsule. The rocket motor pack is jettisoned (step E) before reentry. Before landing, a drogue chute pulls (step G) the capsule out of the heat shield. An airbag is inflated (step H) to cushion the landing (step I).

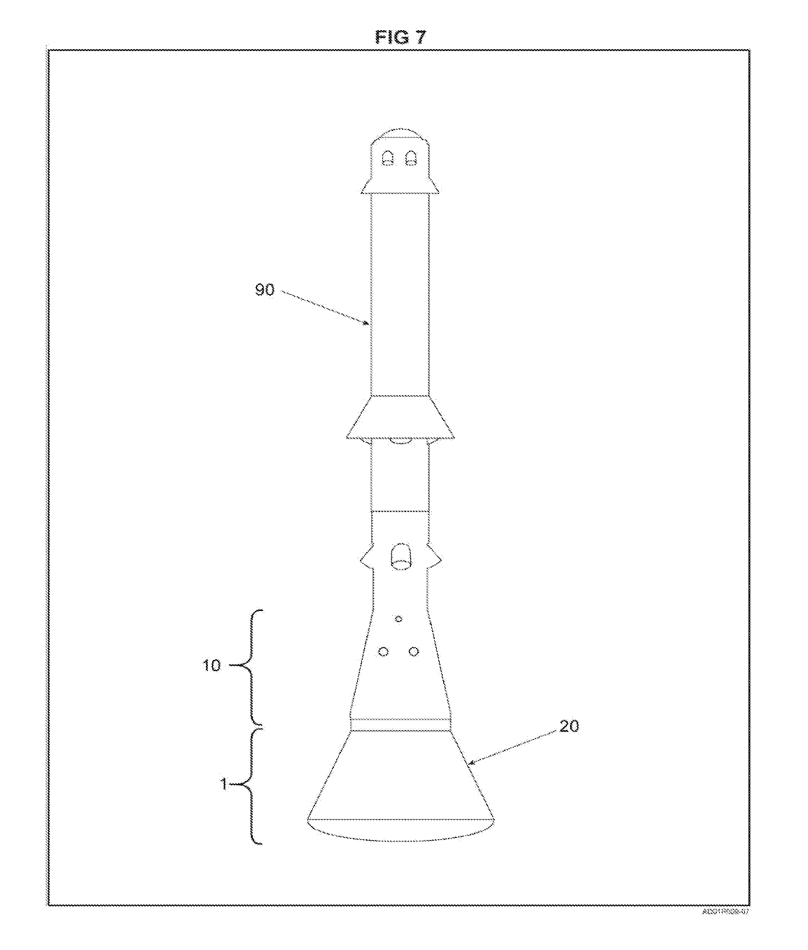

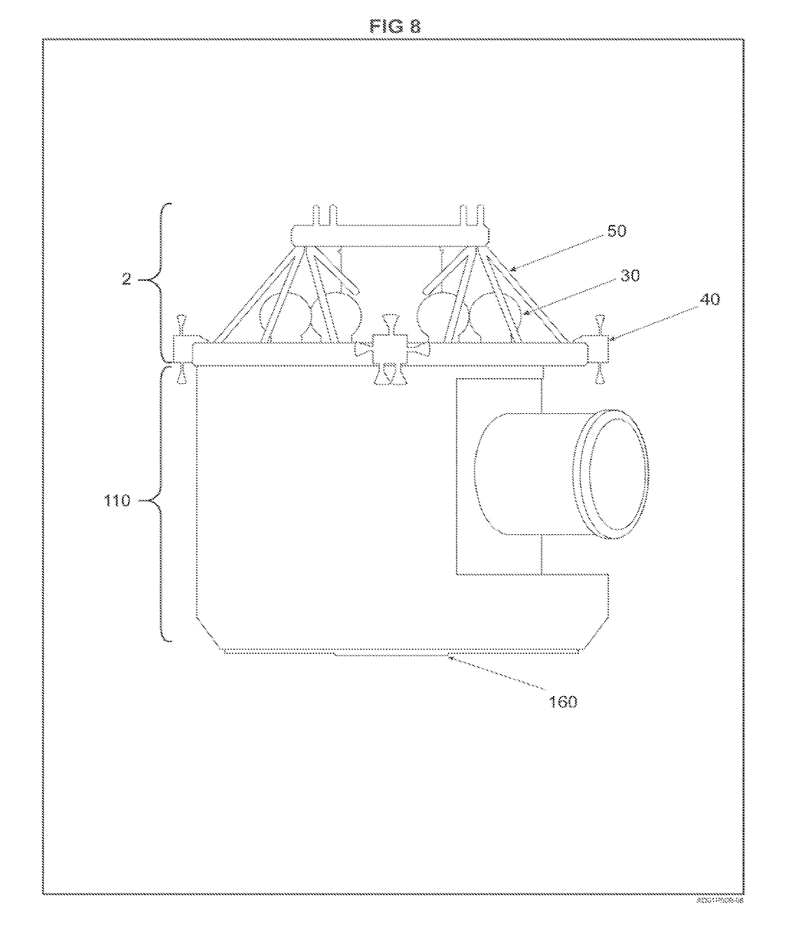

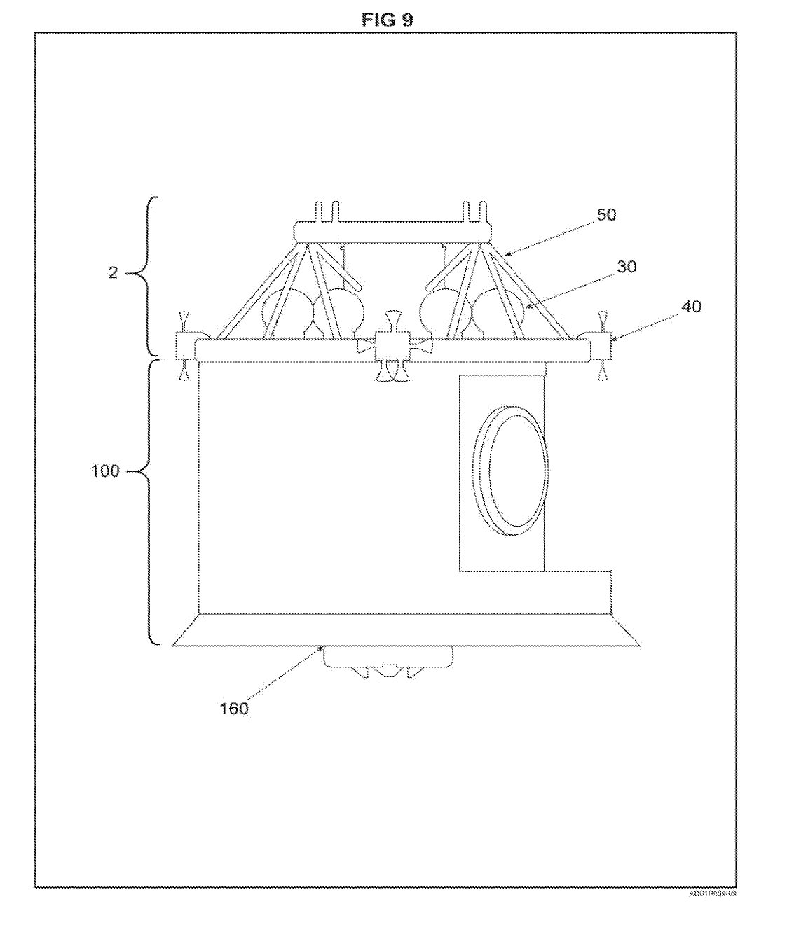

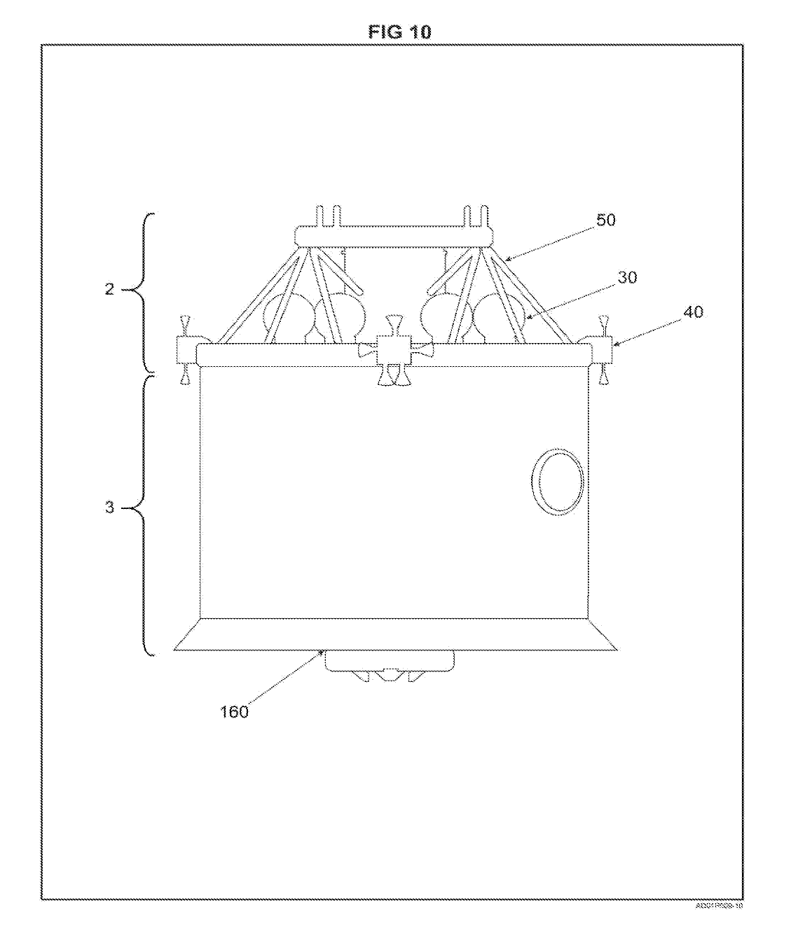

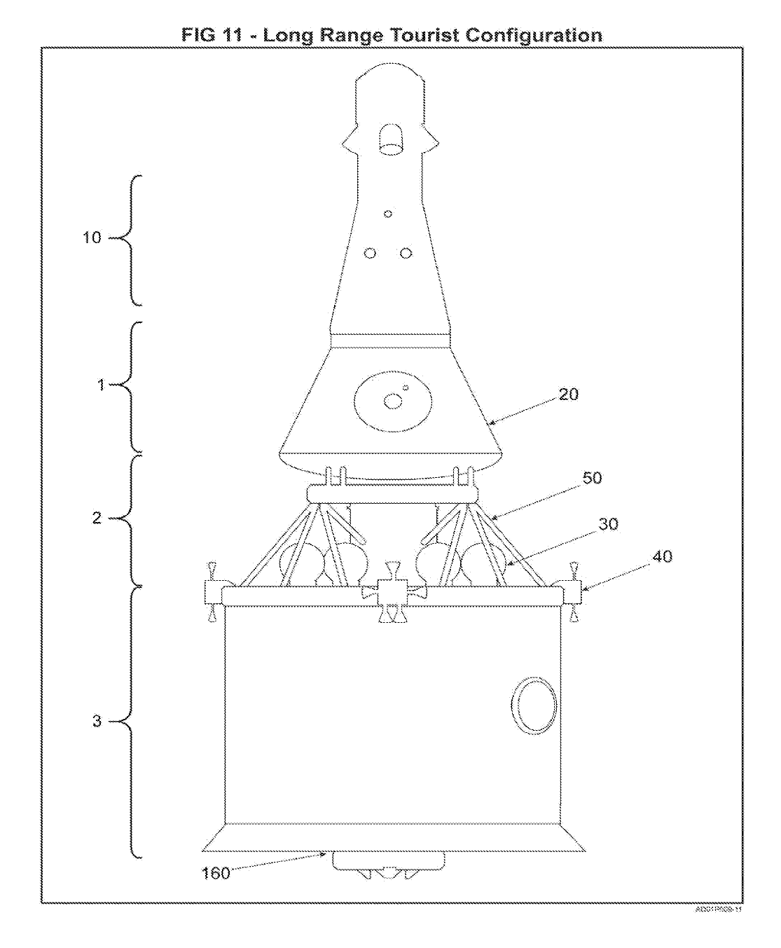

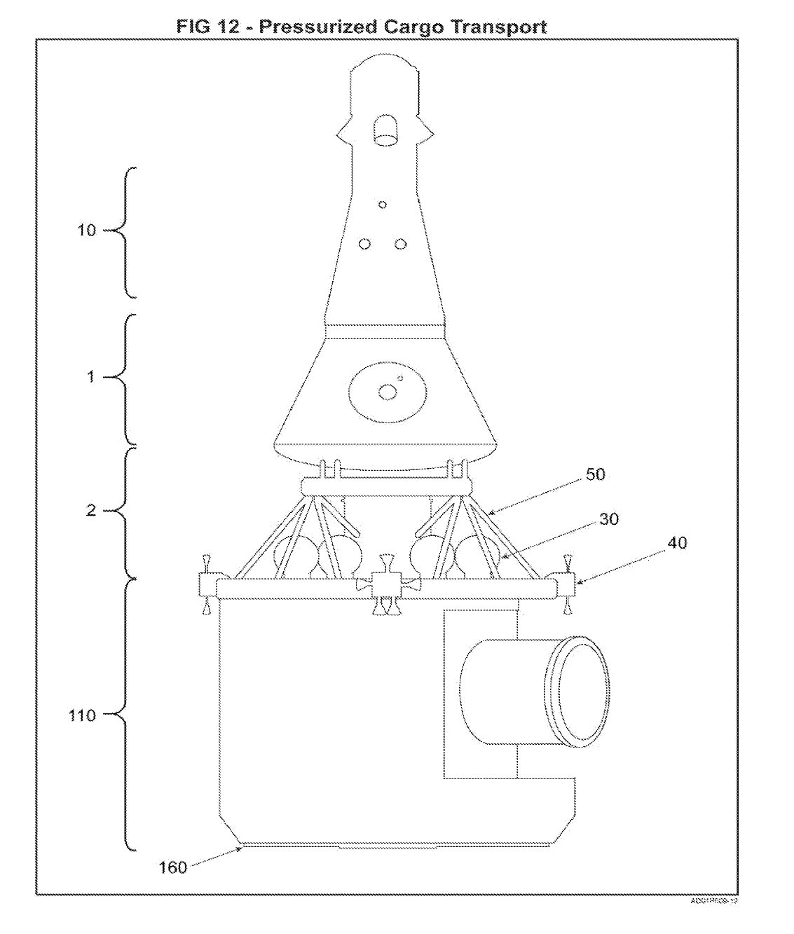

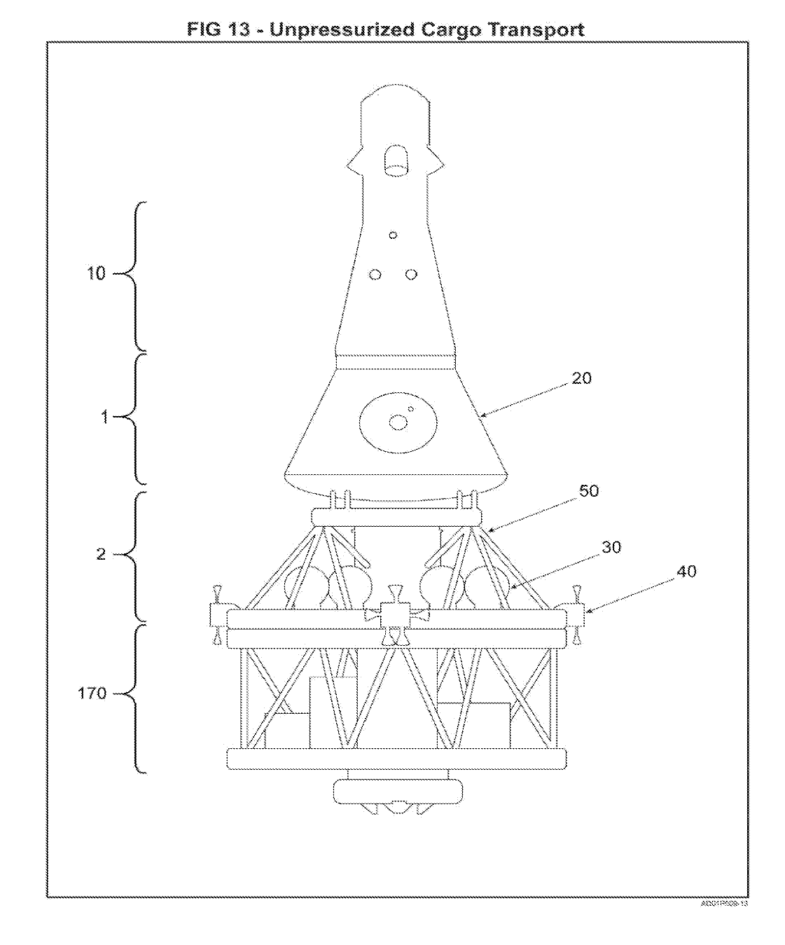

FIG 7 shows a human space vehicle in accordance with the present invention comprising an escape tower 90, a nosecone 10, and a capsule module 1 comprising a capsule 20 and a common bulkhead.

Shown in FIG. 8 is a spacecraft in accordance with an embodiment of the present invention comprising a service module 2 and a D-shaped pressurized cargo module 110, said modules comprising common bulkheads 160.

Shown in FIG. 9 is a spacecraft in accordance with an embodiment of the present invention comprising a service module 2 and a D-shaped pressurized cargo module 100, said modules comprising common bulkheads 160.

Shown in FIG. 10 is a spacecraft in accordance with an embodiment of the present invention comprising a service module 2 and a habitable module 3, said modules comprising common bulkheads.

Shown in FIG. 11 is a spacecraft in a long range tourist configuration in accordance with an embodiment of the present invention comprising a nosecone 10, a capsule module, a service module 2, and a habitable module 3.

Shown in FIG. 12 is a spacecraft in a pressurized cargo transport configuration in accordance with an embodiment of the present invention comprising a nosecone 10, a capsule module 1, a service module 2, and a D-shaped pressurized cargo module 110.

Shown in FIG. 13 is a spacecraft in an unpressurized cargo transport configuration in accordance with an embodiment of the present invention comprising a noscecone 10, a capsule module a service module 2, and an unpressurized cargo module 170.

An embodiment of the present invention could comprise a modular spacecraft comprising one or more modules using a common bulkhead. The modular spacecraft architecture preferably allows for compatibility with a plurality of existing launch vehicles so as to allow for maximum compatibility with minimal cost. The spacecraft architecture can be equipped with different combinations of varying modules in order to best be adapted for the requirements presented by differing mission scenarios.

### Configurations:

### ISS Crew Transport:

This embodiment of the present invention comprises a capsule module 1 that provides the crew of the mission with a pressurized living space from which all of the spacecraft's systems are controllable, an escape tower 90 that allows for emergency separation of the manned capsule from the rest of the spacecraft in the event of an emergency, and an intermediate propulsion stage 2 that allows for maneuvering the spacecraft while it is under the effects of microgravity.

### Short Range Tourist:

This embodiment of the present invention comprises a capsule module 1 that provides the crew of the mission with a pressurized living space from which all of the spacecraft's systems are controllable, an escape tower module 90 that allows for emergency separation of the manned capsule from the rest of the spacecraft in the event of an emergency, an intermediate propulsion stage 2 that allows for maneuvering the spacecraft while it is under the effects of microgravity, and a pressurized cargo module 3 with either a copula or window set in the terminal common bulkhead thus allowing the crew and tourist an extra pressurized living compartment which also allows a view outside of the spacecraft.

Short Range Tourist B:

This embodiment of the present invention comprises; a capsule module 1 that provides the crew with a pressurized living space from which all of the spacecraft's systems are controllable, an escape tower module 90 that allows for emergency separation of the manned capsule from the rest of the spacecraft in the event of an emergency, an intermediate propulsion stage that allows for the maneuvering of the spacecraft while it is under the effects of microgravity, and a D-shaped pressurized, cargo module 100 with either a copula or window set in the terminal common bulkhead, and another copula or window set in the flat portion of the D-shaped module, as shown in FIG. 9, thus allowing the crew and tourist an extra pressurized living compartment that also allows a view outside of the spacecraft.

Pressurized Cargo Transport:

This embodiment of the present invention, as shown in FIG. 12, comprises: a capsule module 1 that provides the crew of the mission with a pressurized living space from which all of the spacecraft's systems are controllable, an intermediate propulsion stage 2 that allows for maneuvering the spacecraft while it is under the effects of microgravity, and a D-shaped pressurized cargo module 110 with a passive common berthing mechanism outfitted on the flat side of the D-shaped pressurized cargo module 110 so that the module can dock with the ISS or a similar vessel and easily transfer cargo between the spacecraft and the ISS or a similar vessel.

Pressurized Cargo Transport (Heavy):

This embodiment of the present invention comprises; a capsule module 1 that provides the crew of the mission with a pressurized living space from which all of the spacecraft's systems are controllable, an intermediate propulsion stage 2 that allows for maneuvering the spacecraft while it is under the effects of microgravity, a D-shaped pressurized cargo module 110 with a passive common berthing mechanism, and a pressurized cargo module 3 that allows for increased pressurized. volume for the pressurized transport of materials.

Pressurized and Unpressurized Cargo Transport:

This embodiment of the present invention comprises; a capsule module 1 that provides the crew of the mission with a pressurized living space from which all of the spacecraft's systems are controllable, an intermediate propulsion stage that allows for maneuvering the spacecraft while it is under the effects of microgravity, a D-shaped pressurized. cargo module 110 with a passive common berthing mechanism outfitted on the flat side of the D-shaped pressurized cargo module 110 so that the module can dock with a spacecraft such as the ISS and easily transfer cargo between the two spacecraft, and an unpressurized cargo module 170 that allows for increased unpressurized volume for the unpressurized transport of materials.

Long Runge Tourist:

This embodiment of the present invention, as shown in FIG 11, comprises; an escape tower module that allows for emergency separation of the manned capsule from the rest of the spacecraft in the event of an emergency, a nosecone 10, a capsule module 1 that provides the crew of the mission with a pressurized living space from which all of the spacecraft's systems are controllable, an intermediate propulsion stage 2 that allows for maneuvering the spacecraft while it is under the effects of microgravity, a pressurized cargo module 3 that provides extra pressurized volume for habitation by the crew and tourists, and a long range propulsion module (not shown) that would provide more delta v such that the spacecraft may perform maneuvers at a longer range than would be possible with just the intermediate propulsion stage.

Capsule:

A capsule module 1, according to the present invention, can comprise an Almaz, Orion, or any other manned or unmanned, pressurized or unpressurized capsule. If the capsule module is manned, then the capsule module will preferably be fixedly connected to the escape tower module 90 so that the escape tower module 90 can pull the manned capsule module 1 away from the rest of the spacecraft in case of life threatening emergency. The capsule module 1 comprises a common bulkhead and may also have a hatch that connects to the common bulkhead on the capsule's underside that allows the transfer of personnel or cargo to or from the capsule to any one of a plurality of other modules.

Escape Tower Module:

An escape tower module 90 according to the present invention contains one or more rocket motors. The escape tower module is attached to the capsule module 1 so that in case of an emergency, the capsule module 1 can be separated from the rest of the spacecraft and pulled away from the rest of spacecraft by firing the escape tower module's rocket motors. In order to be able to perform this crucial separation and escape process at any time throughout the launch, deployment, and re-entry of the spacecraft, the escape tower module cannot be confined within the fairing at time of the spacecraft's launch.

Intermediate Propulsion Module:

According to the present invention, the intermediate propulsion module comprises fuel storage tanks, and one or more rocket motors in fluid communication via piping to fuel storage tanks. The module further comprises a common bulkhead such that the intermediate propulsion module may be attached to another module on one or both sides.

Long Range Propulsion Module:

Long range propulsion module could comprise a long range rocket propulsion module from the Orion spacecraft system. Said long range propulsion module should be mounted to the bottommost common bulkhead interface on the modular spacecraft embodiment.

Pressurized Cargo Module:

A pressurized cargo module 3 according to the present invention comprises an airtight cylindrical shell, said cylindrical shell being capped at either end by a common bulkhead. The common bulkheads at either end of the cylindrical shell can be equipped with any possible combination of common bulkhead additions. Being a pressurized vessel, this pressurized cargo module 3 can be used either as a cargo compartment or as a living compartment connected to the capsule module 1 via a hatch in one of the common bulkheads of the pressurized cargo module 3.

Unpressurized Cargo Module:

An unpressurized cargo module 170 according to the present invention comprises a frame of rigid material that is not air tight. The module has a rigid cylindrical frame capped on both sides by common bulkheads so that the module has an interior volume. The unpressurized cargo module 170 may be outfitted with a hatch disposed in part of the cylindrical frame, so as to allow the ingress and. egress of cargo without going through a hatch in one of the capping common bulkheads.

D-shaped Pressurized Cargo Compartment:

A D-shaped Pressurized Cargo Compartment module 100, 110 according to the present invention has a D-shaped cross-section instead of the cylindrical cross-section of the standard pressurized cargo compartment. Like the standard pressurized cargo compartment the D-shaped pressurized cargo compartment is capped at its ends by common bulkheads. Preferably, the flat portion of the D-shaped pressurized cargo compartment can be modularly fitted with a cupola, a hatch, or an extendable docking mechanism.

Fairing:

A fairing 60 can be placed on top of/around the spacecraft modules for improved aerodynamics. A notable exception to the coverage of the fairing is when manned flights call for using an escape tower. If the spacecraft is configured for manned space missions the fairing would remain around the majority of the modules, however, the escape tower would protrude from the top of the fairing so that if necessary the rocket motors in the tower can fire and pull away the manned capsule module 1 from the rest of the spacecraft without being encumbered or obstructed by the fairing.

Common Bulkhead:

The common bulkhead 160 comprises a rigid structure in the shape of a circle which prevents the flow of air. Common bulkheads can be attached to one another and when each common bulkhead has a hatch, transfer through the bulkheads is possible. The common bulkhead 160 may further comprise a window, cupola, docking adapter, or pressurized tunnel 70 set usually in the middle of a rigid circular structure.

D-Shaped Pressurized Cargo Module:

In this module the perimeter of an end-cap comprising a common bulkhead 160 is affixed to one of the ends of D-shaped tube. The other end of the D-shaped tube is similarly affixed to the perimeter of an end-cap comprising a common bulkhead 160. A docking device, extendible docking device, window, or cupola may be attached to flat surface of the D-shaped tube, Otherwise, the flat surface of D-shaped tube will be solid. The parts of this module are rigidly or movably affixed to one another in such a manner as to have the interior volume of the module hermetically sealed from the exterior volume of the module.

Pressurized Cargo Module:

In this module the circumference of a wall comprising a common bulked 160 is affixed to one of the open ends of cylindrical wall. The other open end of cylindrical wall is similarly affixed to the circumference of common bulkhead 160. A window docking adapter, extendable docking adapter, or cupola can be set into the surface of the cylindrical wall. The parts of this module are rigidly or movably affixed to one another in such a manner as to have the interior volume of the module hermetically sealed from the exterior volume of the module.

Unpressurized Cargo Module:

In this module the circumference of an end-cap comprising a common bulkhead 160 is affixed to one of the open ends of cylindrical cage. The other open end of the cylindrical cage is similarly affixed to the perimeter of an end-cap comprising a common bulkhead 160. A docking adapter or extendable docking adapter may be set into the wall of cylindrical cage. The parts of this module need not be affixed to one another so as to form a hermetic seal.

Long Range Propulsion Module:

An embodiment of this module could comprise the propulsion system from an Orion Multi-Purpose Crew Vehicle service module attached to a. common bulkhead 160.

Escape Tower Module:

This module comprises one or more rocket motors 40, one or more fuel tanks 30, piping, one or more parachutes, and an external fairing. In this module fuel tanks 30, and parachutes are retained within the interior volume of external fairing. Rocket motors 40 are connected to fuel tanks 30 by piping. The nozzle ends of said rockets 40 are in fluid communication with the external fairings exterior volume:

Configurations

ISS Crew Transport:

In this configuration escape tower module 90 is fixedly attached to the nosecone 10 of the capsule module 1. The bottom end of capsule module 1 is removably attached to the common bulkhead 160 of the intermediate propulsion module 2. A fairing 60 may be positioned around the circumference of intermediate propulsion module 2 for improved aerodynamics during launch.

Short Range Tourist:

In this configuration an escape tower module 90 is fixedly attached to the nosecone 10 of capsule module 1. The bottom end 20 of the capsule module 1 is removably attached to the common bulkhead 160 portion of intermediate propulsion module 2. Habitable module 3, pressurized cargo module 110, or D-shaped pressurized cargo module 100 is fixedly attached to the aft end of intermediate propulsion module 2, The interior volume of a habitable module 3, a pressurized cargo module 110 or a D-shaped pressurized cargo module 100 may be in fluid communication with the interior volume of a capsule module 1 through a pressurized tunnel 70 that runs through common bulkheads 160. A fairing 60 may be positioned around the circumference of all modules in this configuration with the exception of the escape tower module 90 and capsule module 1.

Pressurized Cargo Transport:

In this configuration a capsule module 1 is fixedly attached to the common bulkhead 160 portion of intermediate propulsion module 2. Either a pressurized cargo module 10 or a D-shaped pressurized cargo module 100 is fixedly attached by one of its common bulkheads 160 to the other side of the intermediate propulsion module 2. Grapple fixtures 170 may or may not be attached to the intermediate propulsion module 2, where the grapple fixtures 170 may be passive or have power and data capacities. More habitable modules 3, Pressurized cargo modules 110 or D-shaped pressurized cargo modules 100 may optionally be connected (common bulkhead 160 to common bulkhead 160) to the first pressurized cargo module 110. A fairing may be positioned around the circumference of all modules in this configuration so as to improve the aerodynamic properties of the system. The pressurized cargo modules 110 or D-shaped pressurized cargo modules 100 can optionally include modular attachments such as a NASA Docking System (NDS) 130, an Androgynous Peripheral Attach System (ARAS) 120, or a Passive Common Berthing Mechanism. (PCBM) 140.

Unpressurized Cargo Transport:

In this configuration a capsule module 1 is fixedly attached to the common bulkhead 160 portion of intermediate propulsion module 2. Either a pressurized cargo module 110 or a D-shaped pressurized cargo module 100 is fixedly attached by one of its common bulkheads 160 to the other side of the intermediate propulsion module 2. Grapple fixtures 170 may or may not be attached to the intermediate propulsion module 2, where the grapple fixtures 170 may be passive or have power and data capacities. One or more unpressurized cargo modules 220 may optionally be connected (common bulkhead 160 to common bulkhead 160) to the first pressurized cargo module 110. A fairing may be positioned around the circumference of all modules in this configuration so as to improve the aerodynamic properties of the system. The pressurized cargo modules 110 or D-shaped pressurized cargo modules 100 can optionally include modular attachments such as a NASA Docking System (NDS) 130, an Androgynous Peripheral Attach System (APAS) 120, or a Passive Common Berthing Mechanism (PCBM) 140.

Long Range Tourist:

In this configuration escape tower module 90 is fixedly attached to nosecone 10 of a capsule module 1. The bottom end of the capsule module 20 is removably attached to the common bulkhead 160 of intermediate propulsion module 2. Pressurized cargo module 110, or D-shaped pressurized cargo module 100 is fixedly attached. to the aft end of the intermediate propulsion module 2. The common bulkhead 160 of long range propulsion module 2 is fixedly attached to the remaining common bulkhead 160 of the pressurized cargo module 110. The interior volume of pressurized cargo module 110 or D-shaped pressurized cargo module 100 may be in fluid communication with the interior volume of Capsule Module 1 through the use of a pressurized tunnel 70 that runs through common bulkheads 160. A fairing may be positioned around the circumference of all modules in this configuration with the exception of the escape tower module 90 and capsule module 20.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A modular spacecraft comprising:
a capsule module comprising a common bulkhead, and
an additional spacecraft module comprising a common bulkhead, wherein said capsule module's common bulkhead is attached to said additional spacecraft module's common bulkhead.

2. A modular spacecraft according to claim 1 wherein:
said additional spacecraft module is selected from the list consisting of:
a service module,
a pressurized storage module,
an unpressurized storage module,
a short range propulsion module, and
a long range propulsion module.

3. A modular spacecraft according to claim 1 wherein at least one of said common bulkheads comprises solid rigid material with no penetrations.

4. A modular spacecraft according to claim 1 wherein at least one of said common bulkheads comprises a feature selected from the list consisting of: a hatch, a window, or a cupola.

5. A modular spacecraft according to claim 1 wherein at least one of said common bulkheads further comprises a hatch selected from the list consisting of: a NASA Docking System, an Androgynous Peripheral Attach System, or a Passive Common Berthing Mechanism.

6. A modular spacecraft comprising:
a capsule module comprising a common bulkhead,
a reusable reentry payload and docking module comprising a common bulkhead, and
a service module comprising a plurality of common bulkheads,
wherein one of the service module's common bulkheads is attached to the capsule module's common bulkhead, and one of the service module's common bulkheads is attached to the reusable reentry payload and docking module's common bulkhead.

7. A modular spacecraft comprising: a service module comprising a common bulkhead, and an additional spacecraft module comprising a common bulkhead, wherein said service module's common bulkhead is attached to said additional spacecraft module's common bulkhead.

8. A modular spacecraft according to claim 7 wherein said service module has a top and bottom, and wherein said service module comprises: a top common bulkhead at said service module's top and a bottom common bulkhead at said service module's bottom.

9. A modular spacecraft according to claim 8 wherein said top common bulkhead comprises a hatch and said bottom common bulkhead comprises a hatch, and said service module further comprises a pressurized tunnel connecting said top common bulkhead's hatch to said bottom common bulkhead's hatch, and said pressurized tunnel forms a hermetic seal with said top common bulkhead's hatch and said pressurized tunnel forms a hermetic seal with said bottom common bulkhead's hatch.

10. A modular spacecraft according to claim 9 wherein said additional spacecraft module comprises a capsule module wherein said capsule module's common bulkhead is connected to said service module's top common bulkhead.

11. A modular spacecraft according to claim 10 wherein said capsule module's common bulkhead comprises a hatch and said capsule module's common bulkhead forms a hermetic seal with said service module's top common bulkhead.

12. A modular spacecraft according to claim 11 wherein said modular spacecraft further comprises a habitable module whose common bulkhead is attached to said service module's bottom common bulkhead, wherein said habitable module's common bulkhead comprises a hatch and said habitable module's common bulkhead forms a hermetic seal with said service module's bottom common bulkhead.

13. A modular spacecraft according to claim 11 wherein said modular spacecraft further comprises a pressurized cargo module whose common bulkhead is attached to said service module's bottom common bulkhead, wherein said pressurized cargo module's common bulkhead comprises a hatch and said pressurized cargo module's common bulkhead forms a hermetic seal with said service module's bottom common bulkhead.

14. A modular spacecraft according to claim 10 further comprising an unpressurized cargo module having a common bulkhead wherein said unpressurized cargo module's common bulkhead is attached to said service module's bottom common bulkhead.

15. A modular spacecraft according to claim 7 wherein said additional module comprises a cargo module.

16. A modular spacecraft according to claim 15 wherein said cargo module's walls form a D-shaped perimeter comprising a flat section.

17. A modular spacecraft according to claim 116 wherein said flat section of said cargo module's walls comprises a passive common berthing mechanism.

18. A modular spacecraft according to claim 16 wherein said flat section of said cargo module's walls comprises a cupola.

19. A modular spacecraft according to claim 16 wherein said flat section of said cargo module's walls comprises an extendable docking mechanism.

20. A modular spacecraft comprising:
a first spacecraft module comprising a common bulkhead,
a second spacecraft module comprising a common bulkhead,
wherein said first spacecraft module's common bulkhead is connected to said second spacecraft module's common bulkhead.
